(19) United States
(12) Patent Application Publication
(10) Pub. No.: US 2017/0074403 A1
(43) Pub. Date: Mar. 16, 2017

(54) SEAL ASSEMBLY FOR SUPERCRITICAL FLUID CHROMATOGRAPHY

(71) Applicant: Waters Technologies Corporation, Milford, MA (US)

(72) Inventors: Neal B. Almeida, Cumberland, RI (US); Nathan Barrett, Milford, MA (US)

(21) Appl. No.: 15/263,577

(22) Filed: Sep. 13, 2016

Related U.S. Application Data
(60) Provisional application No. 62/218,048, filed on Sep. 14, 2015.

(51) Int. Cl. F16J 15/3232; F04B 53/16; F04B 53/14; F16J 15/3212; F04B 19/22

(52) U.S. Cl. CPC F16J 15/3232; F16J 15/3212; F04B 19/22; F04B 53/14; F04B 53/16

(57) ABSTRACT

A seal assembly for pressurized fluid applications, including supercritical fluid chromatography applications, includes an annular body and a helical wound flat spring. A bore extends through the annular body. The annular body has an outer lip and an inner lip opposed to and spaced apart from each other. The inner lip, outer lip and an overhanging lip portion of the outer lip define a pocket in which the helical wound flat spring is disposed. A load line of the helical wound flat spring is directed substantially along a direction of separation between the inner and outer lips to bias apart the lips. Embodiments of the seal assembly have an improved distribution of contact pressure between the inside diameter of the seal assembly and the plunger with which the inside diameter seals, and between the outside diameter of the seal assembly and a gland surface with which the outside diameter seals.

### RELATED APPLICATION

This application claims the benefit of the earlier filing date of U.S. Provisional Patent Application Ser. No. 62/218,048, filed Sep. 14, 2015 and titled “Seal Assembly for Supercritical Fluid Chromatography,” the entirety of which is incorporated herein by reference.

### FIELD OF THE INVENTION

The invention relates generally to seal assemblies used in pumps. More particularly, the invention relates to a seal assembly for use with supercritical fluids such as compressed carbon dioxide (CO₂).

### BACKGROUND

Seals are important for leakage prevention for applications, such as liquid chromatography, in which a pump moves fluid under pressure. For instance, in liquid chromatography systems, typically one or more high-pressure pumps take in solvents and deliver a mobile phase comprising the solvents to a sample manager, where a sample awaits injection into the mobile phase.

Solvents used for the mobile phase in liquid chromatography often represent environmental hazards. In recent years, supercritical fluid chromatography (SFC) has been developed as an alternative technique. SFC applications frequently use supercritical carbon dioxide (CO₂) as the primary component of the mobile phase and yield separations similar to those performed with conventional normal phase chromatography in less time. A CO₂ mobile phase overcomes the waste and disposal problems associated with many conventional mobile phase components and is often less expensive.

In some applications, the CO₂ is supplied to a SFC system at room temperature. A SFC system pump pressurizes the CO₂ to a system pressure, for example, 1,500 psi (10.3 MPa) or more.

Typically, in liquid chromatography applications a high-pressure seal resides within a gland in a pump head. The outside diameter (OD) of the high-pressure seal provides a seal against a surface of the gland while the inside diameter (ID) of the high-pressure seal provides a seal against a reciprocating plunger in the pump. The ability to seal a supercritical fluid, such as supercritical CO₂, within the pump can present a challenge, especially if the supercritical fluid transitions to a gas phase. In such instances, seals which may be sufficient for high pressure fluids used in conventional liquid chromatography may not be sufficient to seal the mobile phase in SFC applications.

### SUMMARY

In one aspect, the invention features a seal assembly that includes an annular body and a helical wound flat spring. A bore extends through the annular body. The annular body has an inner lip opposed to and spaced apart from an outer lip. The outer lip has an overhanging lip portion. The inner and outer lips and the overhanging lip portion together defining a pocket. The helical wound flat spring is disposed in the pocket such that a load line of the helical wound flat spring is directed substantially along a direction of separation between the inner and outer lips to thereby bias apart the inner and outer lips.

In another aspect, the invention features an actuator that includes a rod, a pump head, a wash housing and a seal assembly. The pump head has a gland and a chamber to receive the rod. The wash housing abuts the pump head and has a hole through which the rod extends into the chamber of the pump head. The seal assembly is disposed in the gland of the pump head and includes an annular body and a helical wound flat spring. The annular body has a bore extending through the body for receiving the rod. The annular body also has an inner lip opposed to and spaced apart from an outer lip. The outer lip has an overhanging lip portion. The spaced apart lips and the overhanging lip portion together define a pocket. The helical wound flat spring is disposed in the pocket such that a load line of the helical wound flat spring is directed substantially along a direction of separation between the inner and outer lips to thereby bias apart the inner and outer lips such that an exterior surface of the outer lip is forced against a surface of the gland of the pump head and an exterior surface of the inner lip is forced against a surface of the rod.

### BRIEF DESCRIPTION OF THE DRAWINGS

The above and further advantages of this invention may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the invention.

FIG. 1 is a cross-sectional view of an actuator having a pump head and a wash housing that may be used as part of a binary solvent manager.

FIG. 2 is a detail view of an embodiment of the plunger seal shown in FIG. 1.

FIG. 3A shows an end view of the plunger seal of FIG. 2.

FIG. 3B shows a side view of the plunger seal of FIG. 3A.

FIG. 3C shows another end view of the plunger seal of FIG. 3A.

FIG. 3D is an isometric view of the plunger seal of FIG. 3A.

FIG. 3E shows a cross-section view of the plunger seal of FIG. 3A.

FIG. 4A is an illustration of a portion of a helical wound flat spring.

FIG. 4B is an illustration of a portion of a canted coil type spring.

FIG. 5A is a detail view of a portion of the helical wound flat spring in contact with the inner lip according to the plunger seal shown in FIG. 3E.

FIG. 5B shows the full helical wound flat spring of FIG. 5A.

FIG. 5C is a detail view of the canted coil spring of FIG. 4B in contact with an inner lip of a plunger seal.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

A helical wound flat spring, as used herein, means a spring formed from a length of material having a rectangular cross section and wound, or otherwise formed, into the shape of a helix or spiral. A helical wound flat spring is structurally similar to a canted coil type spring in some ways; however, the circular cross section of the wire that forms the canted coil type spring is effectively replaced by a wire having a rectangular cross section. One significant difference is that the helical wound flat spring has a substantially linearly increasing load as a function of deflection whereas the canted coil type spring exhibits an almost flat load as a function of deflection for a wide deflection range. The helical wound flat spring is sometimes referred to as a ribbon spring due to the flat nature of the spring wire.

The present teaching will now be described in more detail with reference to embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure.

Liquid chromatography is an example of a field of applications wherein fluids are pumped at elevated pressures. Conventionally, high performance liquid chromatography (HPLC) employs pressures ranging between approximately 1,000 (6.9 MPa) and 6,000 psi (42 MPa). Pressures for performing ultra performance liquid chromatography (UPLC) may reach 15,000 psi (100 MPa) to 20,000 psi (140 MPa). Pressures for performing SFC are similar to those for HPLC; however, SFC generally requires that the entire flow path for the chromatography system be pressurized to maintain the fluid in a supercritical state. Preventing leakage within pumps operating at any of these fluidic pressures is important to the accuracy of the chromatographic results and can represent a significant challenge, especially for SFC systems.

The various embodiments of seal assemblies described herein derive from the discovery that the leakage of pressurized fluid, especially supercritical fluid, within a pump generally appears to be due to insufficient contact pressure between the inside diameter (ID) of the seal assembly and the plunger with which the ID seals, and between the outside diameter (OD) of the seal assembly and a gland surface with which the OD seals. Increasing the spring rate in the seal assembly can improve the sealing force of the ID against the plunger; however, the discontinuity of spring contact along the circumference of the ID of the seal assembly remains as a potential source of leakage. More specifically, the gaps along the surface of the ID between the locations of contact of adjacent coils of the spring are potential leakage paths.

In brief overview, embodiments of seal assemblies described herein improve the sealing capability of high pressure systems and systems using supercritical fluids. For example, the seal assembly is useful for supercritical CO₂ applications in which liquid CO₂ is supplied by one or more pumps to a liquid chromatography system. In some embodiments, the seal assembly includes an annular body and a helical wound flat spring. The annular body has an inner lip opposed to and spaced apart from an outer lip. The outer lip has an overhanging lip portion, and the inner and outer lips along with the overhanging lip portion define a pocket in which the helical wound flat spring resides. A load line of the helical wound flat spring is directed substantially along a direction of separation between the inner and outer lips to bias apart the inner and outer lips.

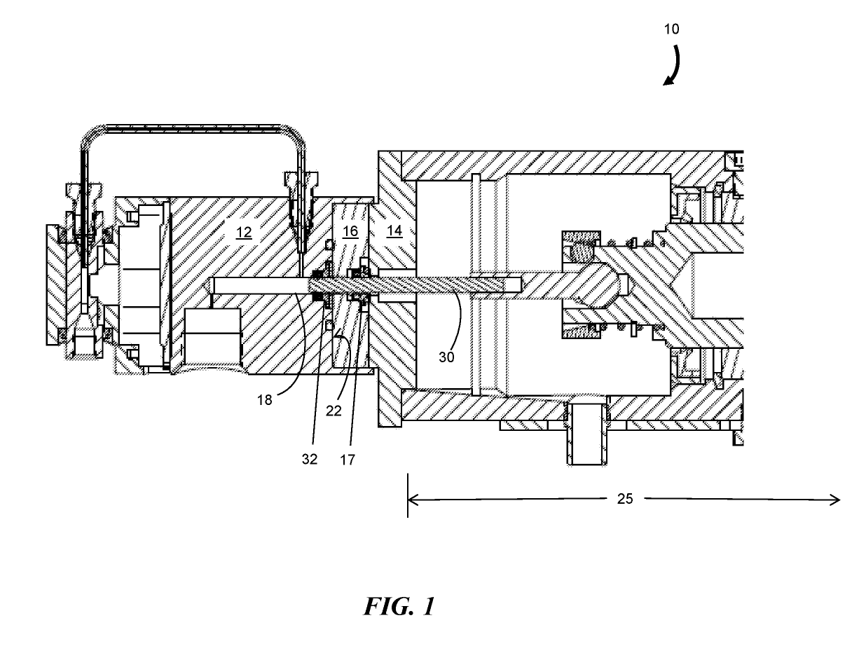

FIG. 1 shows a cross-sectional view of an embodiment of an actuator 10 having a pump head 12 and a wash housing 16 affixed to a support plate 14. In one embodiment, the actuator 10 is a part of a binary solvent manager (BSM), which uses two individual serial flow pumps to draw solvents from their reservoirs and deliver a solvent composition. An example implementation of a BSM is the ACQUITY UPC²® Binary Solvent Manager, manufactured by Waters Corp. of Milford, Mass.

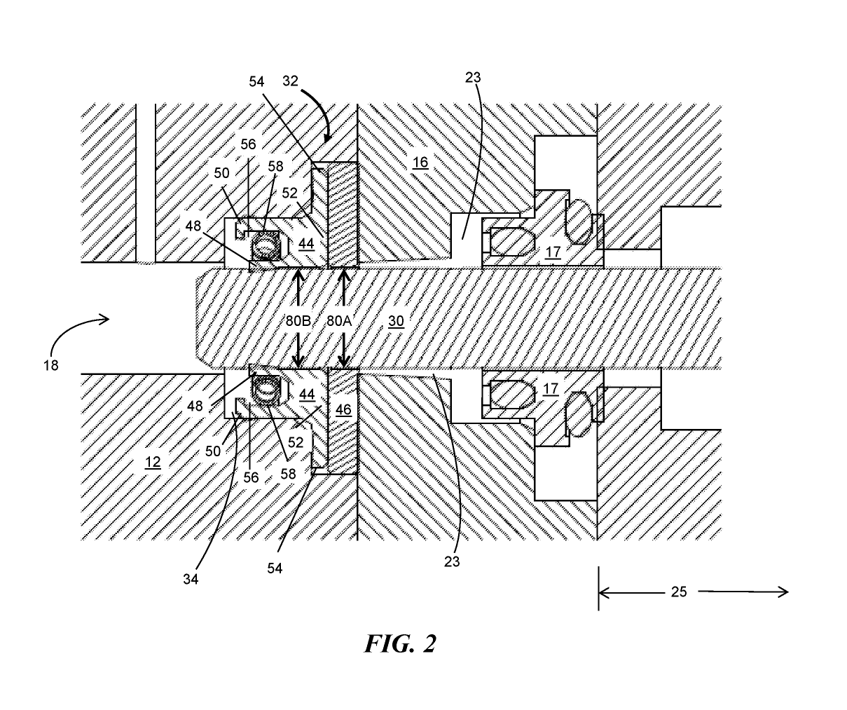

The pump head 12 includes a chamber 18 and a wash-housing abutment surface 22. The pump head 12 also has a recess to receive and align the wash housing 16. The wash housing 16 provides a chamber 23 (FIG. 2) to collect liquid and wash the plunger of any particulate that may form on the plunger surface. A low-pressure seal assembly, for example, a wash seal 17, is used to contain the liquid in the wash housing 16. The chamber 18 has an inlet and an outlet for receiving and discharging fluids, respectively. The actuator 10 also includes an actuator body 25 with a motor and drive mechanism (not shown) mechanically linked to a plunger 30 and an annular plunger seal 32. The plunger 30 extends through the wash seal 17 and the annular plunger seal 32, and into the chamber 18 of the pump head 12.

As an example, the plunger seal 32 is retained within a gland of the pump head 12. In other embodiments, the plunger seal 32 is disposed within a gland of the wash housing 16. Contact between a surface of the inside diameter of the plunger seal 32 and the circumference of the plunger 30 produces an ID radial seal. Contact between one or more surfaces of the outside diameter of the plunger seal 32 and a surface of the gland produces an OD seal. During reciprocating actuator operation, the chamber 18 contains fluid under pressure such as supercritical CO₂. The plunger 30 moves in and out of the chamber 18, causing the pressurized fluid to move from the inlet to the outlet. Pressurized fluid also pushes against the OD and ID contact surfaces of the plunger seal 32.

The actuator 10 shown in FIG. 1 is only one example of a machine within which the seal assembly described herein may be used. The features of the actuator 10 (e.g., the pump head 12, gland, wash housing 16) may be modified to accommodate different embodiments of the plunger seal 32, as described in more detail below. Although described in connection with reciprocating plungers, the seal assemblies can also be used with rotary shafts, such as a shaft that rotates and turns a rotor fitted to a stator. The term “rod” is used herein to broadly encompass plungers, shafts, rods, and pistons, whether reciprocating or rotary.

FIG. 2 shows a detail view of an embodiment of the plunger seal 32 of FIG. 1. The pump head 12 is coupled to the wash housing 16. The gland in the pump head 12 retains the plunger seal 32. The plunger seal 32 includes a ring seal 44 and a backup ring 46. In some embodiments the ring seal 44 is made of a soft plastic and the backup ring 46 is made of a polyether ether ketone (PEEK). In one embodiment, the ring seal 44 is made of ultra high molecular weight polyethylene (UHMWPE). The plunger 30 extends through a bore 80A in the backup ring 46 and a bore 80B in the ring seal 44.

The ring seal 44 has spaced-apart opposing lips 48 and 50, respectively, extending generally orthogonally from a heel portion 52. An extension flange 54 extends laterally from the heel portion 52. The heel portion 52 and extension flange 54 abut one side of the backup ring 46. The opposing lips 48, 50 and heel portion 52 define a spring pocket 56 within which a helical wound flat spring 58 is disposed. The spring 58 produces a near constant force across a large displacement range in the vertical direction in the figure. The inner lip 48 has a contact surface on its inside diameter that seals against the surface of the reciprocating plunger 30. The outer lip 50 has a contact surface on its outside diameter that seals against a surface of the gland in the pump head 12.

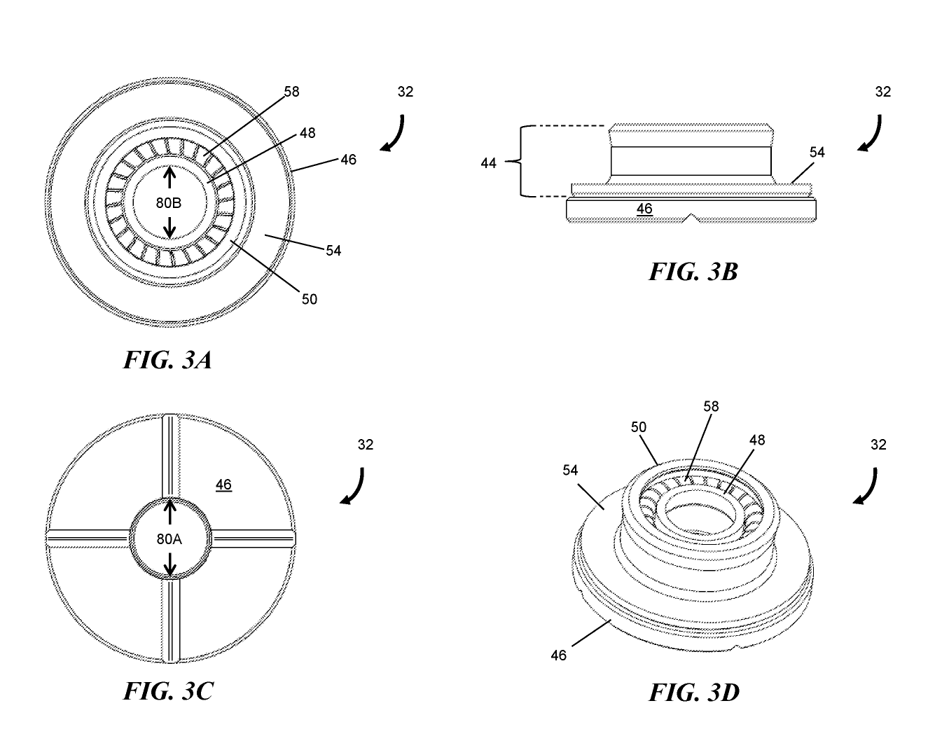

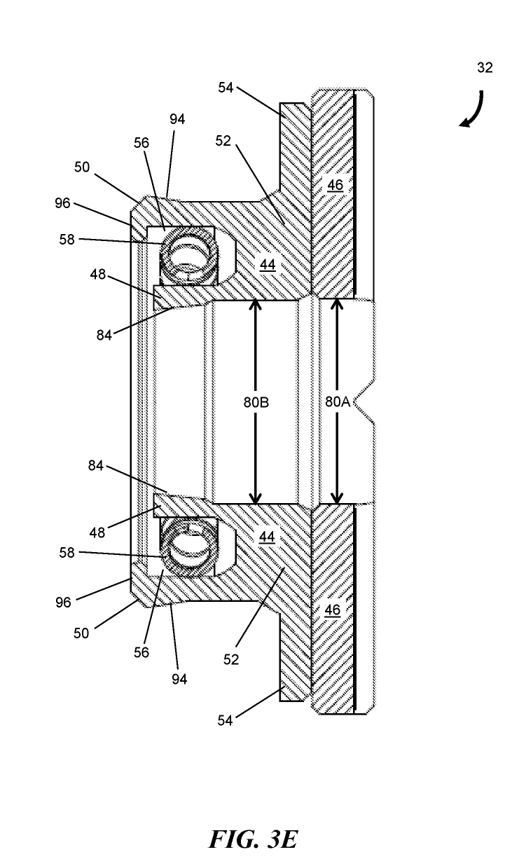

FIGS. 3A to 3D show various views of one embodiment of the plunger seal 32 of FIG. 2. FIG. 3A shows the end of the plunger seal 32 that enters the gland of the pump head 12 first and is press fit into the gland. FIG. 3B shows a side view of the plunger seal 32 and FIG. 3C shows an end view of the plunger seal 32 from the end having the backup ring 46. The bore 80A extends centrally through the backup ring 46. FIG. 3D shows an isometric view of the plunger seal 32, with the backup ring 46 at the bottom of the figure. The plunger seal 32 includes the bore 80B through the ring seal 44, inner lip 48, outer lip 50, extension flange 54 and backup ring 46. By way of a specific numerical example, the outer diameter of the backup ring 46 is approximately 0.40 inch and the diameter of the extension flange 54 is approximately 0.38 inch.

FIG. 3E shows a cross-section view of the seal assembly 32. The bore 80A passes axially through the backup ring 46 of the plunger seal 32 and the bore 80B passes through the ring seal 44. In one embodiment, the bores 80A, 80B are approximately 0.125 inch in diameter. The inner lip 48 has a flare 84 that extends inwardly into the bore 80B, for making contact circumferentially with a surface of the plunger 30. Within the spring pocket 56, the spring 58 is radially oriented and the load is approximately radial and directed perpendicular to the central axis of the bores 80A and 80B. Thus the helical wound flat spring 58 provides a force against the interior surfaces of the inner and outer lips 48 and 50.

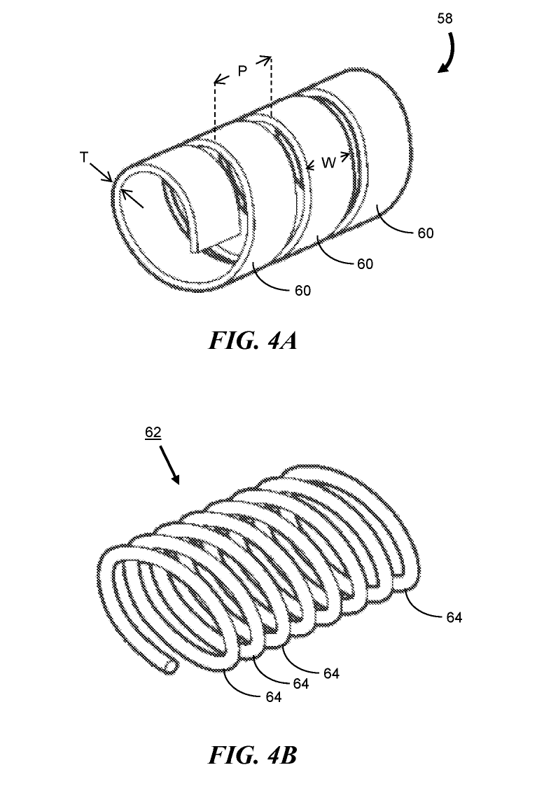

FIG. 4A is an illustration of a portion of the helical wound flat spring 58, showing approximately three loops 60. The full length of the spring 58 is defined by a closed circular path within the spring pocket 56 (FIG. 2). The “wire” used to form the spring 58 has a rectangular cross section of width W and thickness T. For comparison, a detail portion of a canted coil type spring 62 that is known for use in other types of annular seals is shown in FIG. 4B.

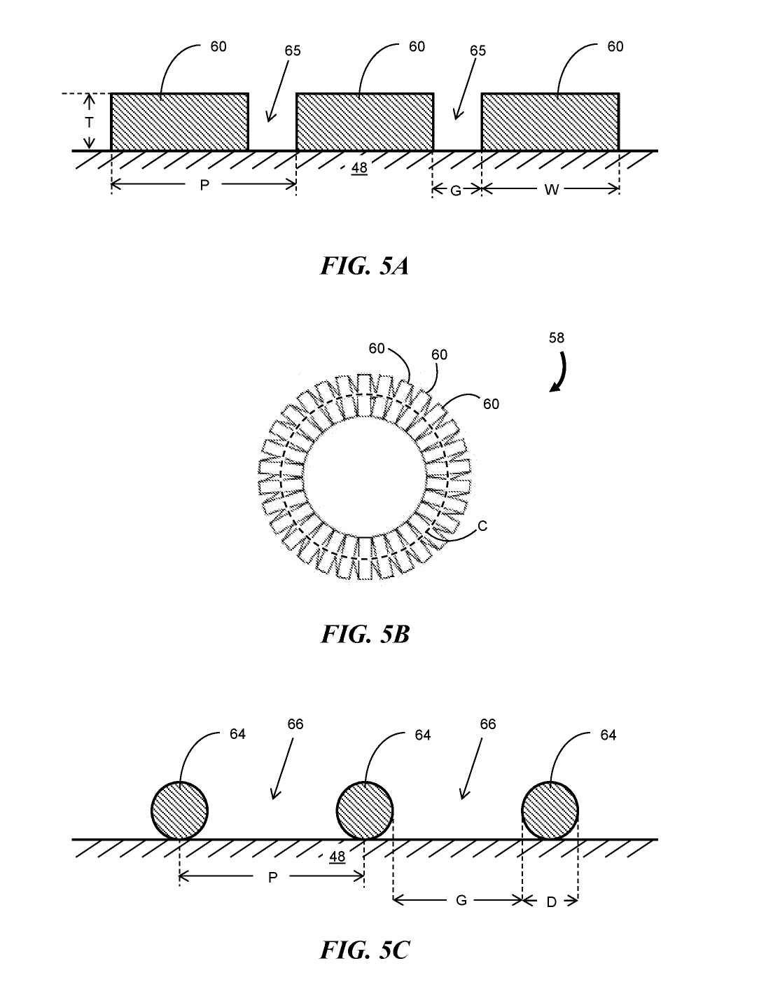

FIG. 5A shows a detail view of a portion of the helical wound flat spring 58 in contact with the inner lip 48 according to the embodiment of the seal assembly 32 shown in FIG. 3E and FIG. 5B shows a full view of the helical wound flat spring 58. As described above, the spring 58 is formed of a flat wire of width W and thickness T. A small gap 65 of width G is present between the two coils 60 for each pair of adjacent coils. For comparison, FIG. 5C shows a detail view of the canted coil spring 62 of FIG. 4B, with a wire diameter D and pitch P, in contact with the inner lip 48. The width G of the gaps 66 between adjacent coils 64 is substantially greater than the diameter D of the coils 64.

In FIG. 5C, the canted coil spring 62 makes contact with the inner lip 48 only along a limited region about the bottom of the circular wire cross section due to the large gaps 66 between adjacent coils 64. Consequently, there is high stress at and near the contact of each coil 64 with the inner lip 48, and significantly less stress in the gaps 66. Thus the less stressed regions in the gaps 66 represent potential leakage paths. When used with high pressure fluids, the lack of uniform loading along the contact surface of the inner lip 48 may result in one or more leaks. This problem can be more pronounced with supercritical fluids, such as supercritical CO₂.

Referring again to FIG. 5A, each coil 60 of the flat wound helical spring 58 makes contact along substantially all of its width W and the gaps 65 between the coils 60 make up a significantly smaller amount of the spring pitch P. The small gaps 65 are sufficient to prevent adjacent coils 60 from rubbing against each other under load. In comparison to the canted coil spring 62, the loading of the helical wound flat spring 58 along the inner lip 48 is more constant and the variation in loading along the contact surface is significantly less. As a result, the sealing of the opposite face of the inner lip 48 against the plunger is improved.

By way of a specific and non-limiting example, a helical wound flat spring 58 formed from flat ribbon stainless steel that can be used in some embodiments of the seal assembly 32 (FIG. 2) is available from Nelson Products, Inc. of Golden, Colorado as part no. H-200-177-0.5-W. The spring has a coil width W of 0.040 in., a thickness T of 0.003 in., a gap width G of 0.012 in. and a circular length C (dashed circle in FIG. 5B) of 0.500 in.

Although not shown, it will be appreciated that the helical wound flat spring 58 interfaces with the face of the outer lip 50 of the seal assembly 32 in a similar manner to better distribute the loading of a surface portion 94 of the OD of the outer lip 50 against the gland surface (FIG. 3E).

Referring again to FIG. 2 and FIG. 3E, the fluidic seals provided by the plunger seal 32 are, in part, pressure activated. The pressurized fluid pushes against a face of the inner lip 48, forcing the flare 84 into the bore 80B and producing a seal against the surface of the plunger 30. In addition, the pressurized fluid fills the spring pocket 56, pushing against the interior surface of the outer lip 50 to force a surface portion 94 of the OD of the outer lip 50 against a gland surface of the pump head 12, thereby producing an OD seal. The fluidic push against the face 96 of the outer lip 50 further contributes to the forces producing this OD seal. The force provided by the helical wound flat spring 58 further contributes to these sealing forces.

While the invention has been shown and described with reference to specific preferred embodiments, it should be understood by those skilled in the art that various changes in form and detail may be made therein without departing from the spirit and scope of the invention as defined by the following claims. For example, although described herein primarily with respect to reciprocating applications, more generally the various embodiments of seal assemblies can be used with low and high pressure fluids and supercritical fluids in both low pressure and high pressure reciprocating and rotary applications.

1. A seal assembly comprising:
an annular body having a bore extending therethrough, the annular body having an inner lip opposed to and spaced apart from an outer lip, the outer lip having an overhanging lip portion, the inner and outer lips and the overhanging lip portion together defining a pocket; and
a helical wound flat spring disposed in the pocket such that a load line of the helical wound flat spring is directed substantially along a direction of separation between the inner and outer lips to thereby bias apart the inner and outer lips.

2. The seal assembly of claim 1 wherein the helical wound flat spring has a plurality of loops and is formed of a flat ribbon having a width that is greater than a gap width between adjacent loops in the plurality of loops.

3. The seal assembly of claim 1 wherein the helical wound flat spring is formed from a stainless steel flat ribbon.

4. The seal assembly of claim 1, further comprising a backup ring in contact with the annular body, the contact ring having a bore in coaxial alignment with the bore of the annular body and configured to receive a rod of a pump head.

5. An actuator comprising:
a rod;
a pump head with a gland and a chamber to receive the rod;
a wash housing abutting the pump head, the wash housing having a hole through which the rod extends into the chamber of the pump head; and
a seal assembly disposed in the gland of the pump head, the seal assembly comprising:
an annular body having a bore extending therethrough for receiving the rod, the annular body having an inner lip opposed to and spaced apart from an outer lip, the outer lip having an overhanging lip portion, the spaced apart lips and the overhanging lip portion together defining a pocket; and
a helical wound flat spring disposed in the pocket such that a load line of the helical wound flat spring is directed substantially along a direction of separation between the inner and outer lips to thereby bias apart the inner and outer lips such that an exterior surface of the outer lip is forced against a surface of the gland of the pump head and an exterior surface of the inner lip is forced against a surface of the rod.

6. The actuator of claim 5, wherein the gland has a wedge-shaped corner opposite the chamfer of the overhanging lip portion, and wherein pressurized fluid urges the chamfer of the overhanging lip portion into the wedge-shaped corner of the gland.

7. The actuator of claim 5, further comprising a drive mechanism coupled to the rod and configured to move the rod in a reciprocating motion.

8. The actuator of claim 5, further comprising a drive mechanism coupled to the rod and configured to rotate the rod.

9. The actuator of claim 5 wherein the helical wound flat spring has a plurality of loops and is formed of a flat ribbon having a width that is greater than a gap width between adjacent loops in the plurality of loops.

10. The actuator of claim 5 wherein the helical wound flat spring is formed from a stainless steel flat ribbon.

11. The actuator of claim 5 wherein the seal assembly further comprises a backup ring in contact with the annular body, the contact ring having a bore in coaxial alignment with the bore of the annular body and configured to pass the rod.
